(19) United States
(12) Patent Application Publication
(10) Pub. No.: US 2025/0007048 A1
(43) Pub. Date: Jan. 2, 2025

(54) SECONDARY BATTERY

(71) Applicant: TOYOTA JIDOSHA KABUSHIKI KAISHA, Toyota-shi (JP)

(72) Inventors: Yosuke SHIMURA, Toyota-shi (JP); Yoshiro OBAYASHI, Toyota-shi (JP); Atsushi YAMANAKA, Nagoya-shi (JP); Masashi CHIHARA, Nagoya-shi (JP); Kazuki SUGIE, Miyoshi-shi (JP); Kosuke YONEKAWA, Nisshin-shi (JP); Yasuhiro HIRAO, Toyota-shi (JP)

(73) Assignee: TOYOTA JIDOSHA KABUSHIKI KAISHA, Toyota-shi (JP)

(21) Appl. No.: 18/736,865

(22) Filed: Jun. 7, 2024

(30) Foreign Application Priority Data
Jun. 27, 2023 (JP) 2023-104710

(51) Int. Cl. H01M 50/103; H01M 50/636

(52) U.S. Cl. CPC H01M 50/103; H01M 50/636

(57) ABSTRACT

In a secondary battery, a first end face portion extends toward a second side surface portion, from one end of a first side surface portion in the width direction. A second end face portion extends toward a first side surface portion, from one end of the second side surface portion in the width direction. An end face weld connects respective leading ends of the first and second end face portions to each other. The leading end of the first end face portion is located closer to a center of the housing in the width direction, than a joint at which it is connected to the first side surface portion. The leading end of the second end face portion is located closer to the center of the housing in the width direction, than a joint at which it is connected to the second side surface portion.

### CROSS REFERENCE TO RELATED APPLICATIONS

This nonprovisional application is based on Japanese Patent Application No. 2023-104710 filed on Jun. 27, 2023 with the Japan Patent Office, the entire contents of which are hereby incorporated by reference.

### BACKGROUND

### Field

The present disclosure relates to a secondary battery.

### Description of the Background Art

Japanese Patent Laying-Open No. 2013-125737 discloses a secondary battery including a case for accommodating an electrode assembly. The main body of the case is formed by bending one metal plate and welding edges of the bent metal plates. The metal plate includes a bottom surface portion, a pair of side surface portions, and four half end faces. The edges of the half end face portions opposed to each other are abutted and joined by welding.

### SUMMARY

In order to improve the energy density of the secondary battery, it is required to increase the size of the housing of the secondary battery. In the secondary battery disclosed in Japanese Patent Laying-Open No. 2013-125737, it has been studied to make the case longer in the direction (width direction) in which the end faces are aligned. However, if the case is elongated in the width direction, the weld on the end face may protrude in the width direction, which may make it difficult to handle the secondary battery.

The present disclosure is made in view of the above problem, and it is an object of the present disclosure to provide a secondary battery in which protrusion of the weld on the end face can be suppressed.

A secondary battery according to the present disclosure includes an electrode assembly and a housing. The housing contains the electrode assembly. The housing has a dimension in a height direction, a dimension in a thickness direction, and a dimension in a width direction, and the dimension in the width direction is longer than the dimension in the height direction and the dimension in the thickness direction. The thickness direction is orthogonal to the height direction. The width direction is orthogonal to both the height direction and the thickness direction. The housing includes a main body provided with an opening, and a sealing body closing the opening. The main body includes a bottom surface portion, a first side surface portion, a second side surface portion, a first end face portion, a second end face portion, and an end face weld. The bottom surface portion is located on one side in the height direction. The first side surface portion extends upright along the height direction, from one end of the bottom surface portion in the thickness direction. The second side surface portion extends upright along the height direction, from the other end of the bottom surface portion in the thickness direction. The first end face portion extends toward the second side surface portion, from one end of the first side surface portion in the width direction. The second end face portion extends toward the first side surface portion, from one end of the second side surface portion in the width direction. The end face weld connects a leading end of the first end face portion and a leading end of the second end face portion to each other. The leading end of the first end face portion is located closer to a center of the housing in the width direction, than a joint at which the first end face portion is connected to the first side surface portion. The leading end of the second end face portion is located closer to the center of the housing in the width direction, than a joint at which the second end face portion is connected to the second side surface portion.

In the above configuration, since respective leading ends of the first end face portion and the second end face portion are positioned in the above-described manner, the end face weld can be prevented from protruding in the width direction.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view of a secondary battery according to an embodiment.

FIG. 2 is an exploded perspective view of the secondary battery according to the embodiment.

FIG. 3 is a cross-sectional view taken along the line III-III shown in FIG. 1.

FIG. 4 is a view of the secondary battery according to the embodiment as viewed from the end face side.

FIGS. 5A and 5B are diagrams schematically showing a process of molding the main body in one embodiment.

FIG. 6 is a cross-sectional view taken along the line VI-VI shown in FIG. 1.

### DESCRIPTION OF THE PREFERRED EMBODIMENTS

An embodiment of the present disclosure will be described with reference to the drawings. In the drawings referred to below, the same or corresponding members are denoted by the same reference numerals.

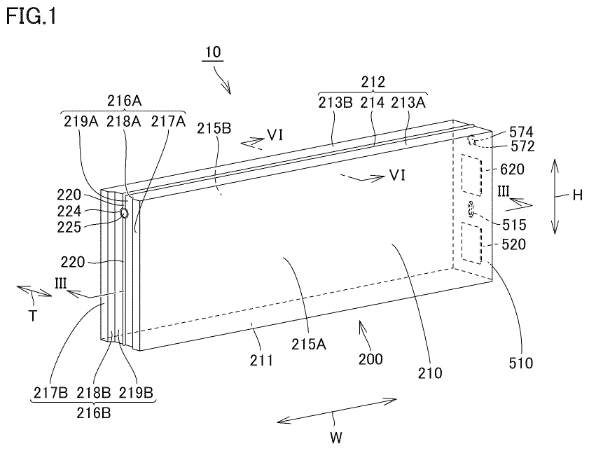

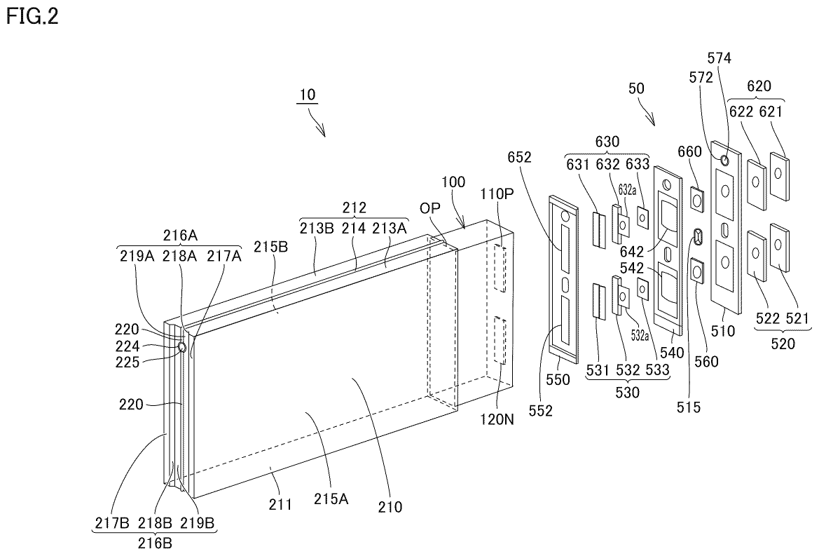

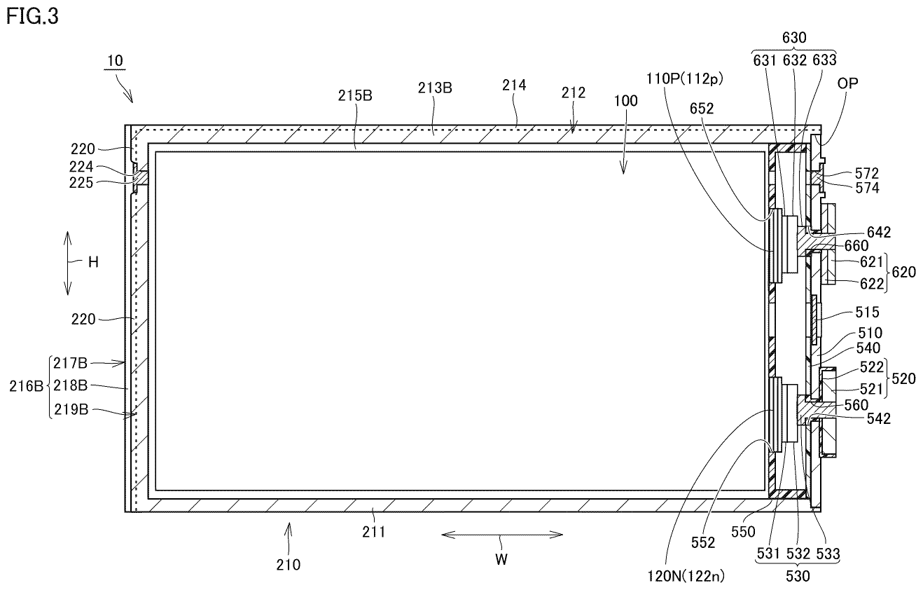

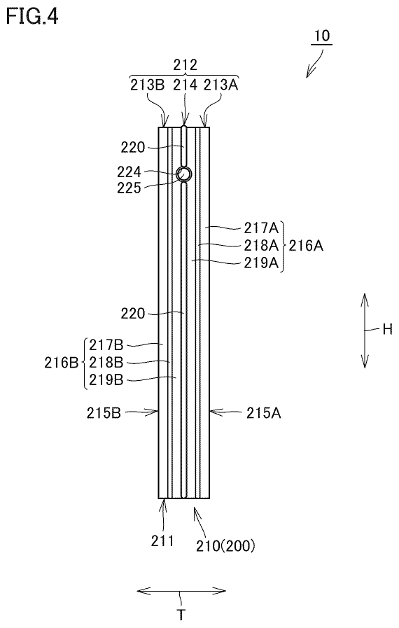

FIG. 1 is a perspective view of a secondary battery according to an embodiment. FIG. 2 is an exploded perspective view of the secondary battery according to the embodiment. FIG. 3 is a cross-sectional view taken along the line III-III shown in FIG. 1. FIG. 4 is a view of the secondary battery according to the embodiment as viewed from the end face side.

As shown in FIGS. 1 to 4, a secondary battery 10 according to an embodiment of the present disclosure includes an electrode assembly 100, a housing 200, a positive electrode member 620 as a positive electrode terminal, and a negative electrode member 520 as a negative electrode terminal.

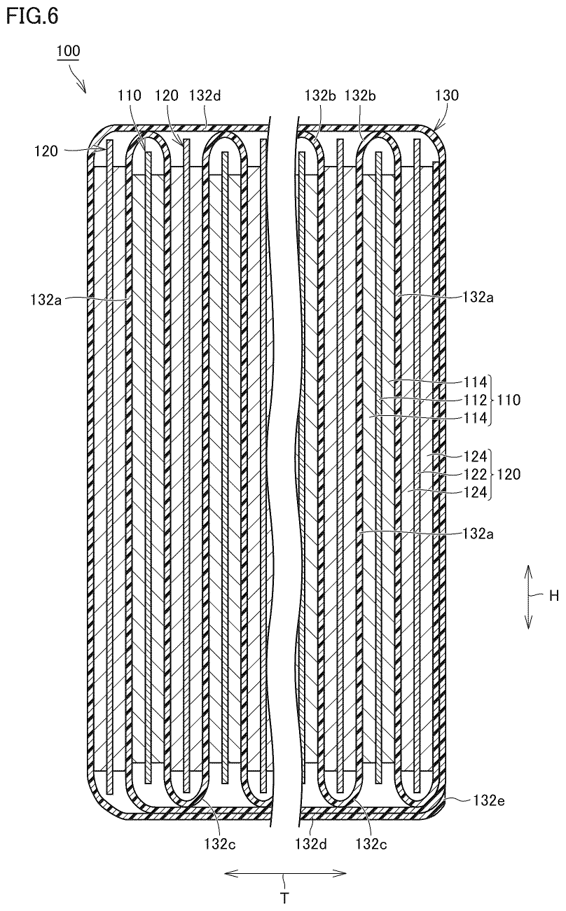

The housing 200 has a substantially rectangular parallelepiped shape. The housing 200 is configured such that the dimension in the width direction W is longer than the dimension in the height direction H and the dimension in the thickness direction T. The thickness direction T is a direction orthogonal to the height direction H. The width direction W is a direction orthogonal to both the height direction H and the thickness direction T. The thickness direction T is a direction parallel to a direction in which the positive electrode 110 and the negative electrode 120 (see FIG. 6) described later are arranged side by side.

The housing 200 contains the electrode assembly 100 and an electrolyte solution (not shown). The housing 200 includes a main body 210 having an opening OP and a sealing body 510 that closes the opening OP.

The opening OP of the main body 210 is provided on one side in the width direction W. The main body 210 is made of metal such as aluminum.

The main body 210 includes a bottom surface portion 211, a top surface portion 212, a first side surface portion 215A, a second side surface portion 215B, a first end face portion 216A, a second end face portion 216B, an end face weld 220, a liquid injection port 224, and a sealing member 225.

The bottom surface portion 211 is positioned on one side in the height direction H. The bottom surface portion 211 has a substantially rectangular outer shape when viewed from the height direction H.

The top surface portion 212 is positioned on the other side in the height direction H. The top surface portion 212 has a substantially rectangular outer shape when viewed from the height direction H.

In this embodiment, the top surface portion 212 includes a first top surface portion 213A, a second top surface portion 213B, and a top surface weld 214.

The first top surface portion 213A and the second top surface portion 213B face each other in the thickness direction T. The first top surface portion 213A and the second top surface portion 213B are joined to each other by welding. The top surface weld 214 is formed by the welding. The top surface weld 214 extends in one direction along the width direction W.

The top surface portion 212 may be a single plate-like member as a whole. When the main body 210 has an opening opposite to the bottom surface portion 211, the top surface portion 212 may be a sealing body that seals the opening.

The first side surface portion 215A extends upright along the height direction H, from one end of the bottom surface portion 211 in the thickness direction T. The second side surface portion 215B extends upright along the height direction H, from the other end of the bottom surface portion 211 in the thickness direction T. The first side surface portion 215A and the second side surface portion 215B have a rectangular outer shape when viewed from the thickness direction T. The first side surface portion 215A and the second side surface portion 215B may be inclined with respect to the height direction H. The first side surface portion 215A and the second side surface portion 215B may extend closer to each other away from the bottom surface portion 211.

The first side surface portion 215A is connected to the top surface portion 212, specifically, connected to an edge of the first top surface portion 213A. The second side surface portion 215B is connected to the top surface portion 212 and specifically connected to an edge of the second top surface portion 213B.

The first end face portion 216A extends from one end of the first side surface portion 215A in the width direction W, toward the second side surface portion 215B. The leading end of the first end face portion 216A is located closer to the center of the housing 200 in the width direction W, than the joint at which the first end face portion is connected to the first side surface portion 215A.

The first end face portion 216A includes a first base portion 217A, a first inner surface portion 218A, and a first leading end portion 219A. The first base portion 217A is contiguous from the first side surface portion 215A and extends in the thickness direction T. The first inner surface portion 218A extends from the first base portion 217A toward the center side of the housing 200. The first inner surface portion 218A is inclined obliquely with respect to the width direction W. The first leading end portion 219A extends from the first inner surface portion 218A along the thickness direction T, and has a leading end of the first end face portion 216A.

The second end face portion 216B extends from one end of the second side surface portion 215B in the width direction W, toward the first side surface portion 215A. The leading end of the second end face portion 216B is located closer to the center of the housing 200 in the width direction W, than the joint at which the second end face portion is connected to the second side surface portion 215B.

The second end face portion 216B includes a second base portion 217B, a second inner surface portion 218B, and a second leading end portion 219B. The second base portion 217B is contiguous from the second side surface portion 215B and extends in the thickness direction T. The second inner surface portion 218B extends from the second base portion 217B toward the center side of the housing 200. The second inner surface portion 218B is inclined obliquely with respect to the width direction W. The second leading end portion 219B extends from the second inner surface portion 218B along the thickness direction T, and has a leading end of the second end face portion 216B.

The end face weld 220 connects the leading end of the first end face portion 216A and the leading end of the second end face portion 216B to each other. That is, the end face weld 220 is formed by connecting the leading end of the first end face portion 216A and the leading end of the second end face portion 216B by welding. The welding method is not particularly limited, but may be, for example, laser welding. The end face weld 220 includes a weld bead formed by the welding. The weld bead protrudes from the first end face portion 216A and the second end face portion 216B toward the outside of the housing 200.

The end face weld 220 extends only in one direction along the height direction H. The end face weld 220 is located on the first leading end portion 219A and the second leading end portion 219B. The end face weld 220 is located closer to the center of the housing 200 than the first base portion 217A and the second base portion 217B in the width direction W.

In the present embodiment, the main body 210 includes a plurality of end face welds 220 as the above-described end face welds 220. The plurality of end face welds 220 are spaced apart from each other. The plurality of end face welds 220 are arranged in the height direction H. Further, the end face weld 220 may be provided so as to be continuous with the top surface weld 214.

Further, in the present embodiment, one end edge in the height direction H of 216A and 216B is also joined to the bottom surface portion 211 by welding. The other end edge in the height direction of the first end face portion 216A and the second end face portion 216B is also joined to the top surface portion 212 by welding.

The liquid injection port 224 is a through hole for injecting an electrolyte solution into the housing 200 during the manufacturing process of the secondary battery 10. The sealing member 225 seals the liquid injection port 224. The sealing member 225 is provided to seal the liquid injection port 224 after the electrolyte solution is injected into the housing 200.

The liquid injection port 224 is provided between the first leading end portion 219A and the second leading end portion 219B. The sealing member 225 is located closer to the center of the housing 200 than the first base portion 217A and the second base portion 217B in the width direction W. The shape of the hole of the liquid injection port 224 is not particularly limited, but is, for example, a circular shape. The main body 210 may have a plurality of liquid injection ports 224 as the liquid injection ports 224 described above.

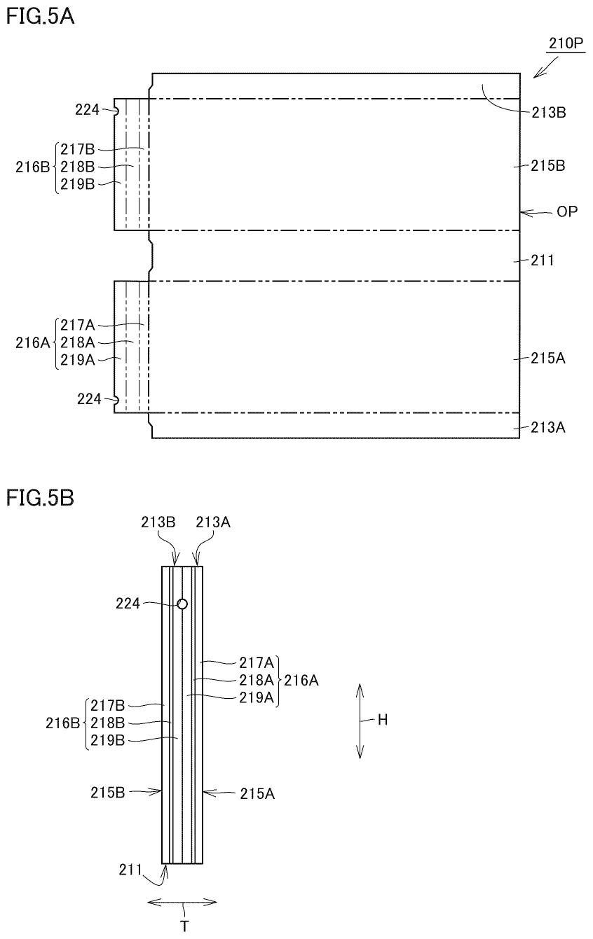

Here, a method of molding the main body 210 will be described. FIG. 5A is a plan view showing a plate-like member prepared for molding the body portion in one embodiment. FIG. 5B is a plan view showing a state immediately after bending the plate-like member in one embodiment. In the plate-like member 210P shown in FIGS. 5A and 5B, portions corresponding to the respective components of the main body 210 are denoted by the same reference numerals as the reference numerals indicating the respective components of the main body 210.

As shown in FIG. 5A, the plate-like member 210P has a plate-like outer shape. Specifically, the plate-like member 210P is prepared by punching a thin plate made of aluminum. At this time, a plurality of notches corresponding to the liquid injection port 224 are formed in the plate-like member 210P.

Then, as shown in FIGS. 5A and 5B, by bending the plate-like member 210P at a plurality of positions, the bottom surface portion 211, the first top surface portion 213A, the second top surface portion 213B, the first side surface portion 215A, the second side surface portion 215B, the first end face portion 216A, and the second end face portion 216B are molded. Therefore, the main body 210 can be easily molded into various sizes. Each of the above-described surface portions may be molded by roll forming the plate-like member 210P. Then, by welding the leading ends of the plate-like members 210P molded in this manner so as to avoid a notch corresponding to the liquid injection port 224, the top surface weld 214, the end face weld 220, and the like are formed (see FIG. 4), and the main body 210 is molded. The opening OP of the main body 210 is formed by respective edges of the bottom surface portion 211, the top surface portion 212, the first side surface portion 215A, and the second side surface portion 215B.

As shown in FIGS. 1 to 3, the sealing body 510 closes the opening OP. The sealing body 510 has a flat plate shape. The sealing body 510 is made of metal such as aluminum. The sealing body 510 is provided with a negative electrode member 520 and a positive electrode member 620. The sealing body 510 is fixed to the opening OP by, for example, laser welding. The sealing body 510 is provided with a pressure release valve 515. The pressure release valve 515 is provided so as to break when the internal pressure of the housing 200 becomes equal to or higher than a predetermined pressure. When the pressure release valve 515 is broken, the gas in the housing 200 is discharged to the outside of the housing 200, so that the internal pressure in the housing 200 decreases.

The negative electrode member 520 is provided on the outer surface of the sealing body 510. The negative electrode member 520 functions as a negative electrode terminal. The negative electrode member 520 includes a negative electrode terminal plate 521 and an insulating plate 522.

The negative electrode terminal plate 521 is formed in a substantially rectangular parallelepiped shape. The negative electrode terminal plate 521 is held by an insulating plate 522. The insulating plate 522 is fixed to the outer surface of the sealing body 510. The insulating plate 522 insulates the sealing body 510 from the negative electrode terminal plate 521. Each of the negative electrode terminal plate 521 and the insulating plate 522 is provided with a through hole through which a negative electrode connecting pin 533 described later is inserted.

The positive electrode member 620 is provided on the outer surface of the sealing body 510. The positive electrode member 620 functions as a positive electrode terminal. The positive electrode member 620 includes a positive electrode terminal plate 621 and a terminal block 622.

The positive electrode terminal plate 621 is formed in a rectangular parallelepiped shape. The positive electrode terminal plate 621 is made of a metal such as aluminum.

The terminal block 622 is formed in a rectangular parallelepiped shape. The terminal block 622 is made of a metal (e.g., iron) different from the metal constituting the positive electrode terminal plate 621. The terminal block 622 is fixed to the outer surface of the sealing body 510 by welding or the like. The positive electrode terminal plate 621 is fixed to the terminal block 622 by welding or the like. The main body 210 and the sealing body 510 are electrically connected to the positive electrode terminal plate 621 via the terminal block 622, and are charged to the same polarity as the positive electrode terminal plate 621. Each of the positive electrode terminal plate 621 and the terminal block 622 is formed with a through hole through which a positive electrode connecting pin 633 described later is inserted.

An insulating plate may be disposed between the positive electrode member 620 and the sealing body 510 to electrically insulate the positive electrode member 620 from the sealing body 510. In this case, an insulating plate may be disposed instead of the terminal block 622, or an insulating plate may be disposed between the terminal block 622 and the sealing body 510.

The secondary battery 10 further includes a negative electrode connecting member 530, a positive electrode connecting member 630, a first insulating member 540, a second insulating member 550, and insulators 560, 660.

The negative electrode connecting member 530 connects the negative electrode current collecting portion 120N and the negative electrode terminal plate 521. The negative electrode current collecting portion 120N is formed by bundling a plurality of negative electrode tabs 122n to be described later in the electrode assembly 100. The negative electrode connecting member 530 includes a negative-electrode-side first negative electrode current collector 531, a negative-electrode-side second negative electrode current collector 532, and a negative electrode connecting pin 533.

The negative-electrode-side first negative electrode current collector 531 is formed of a thin plate-shaped conductive member. The negative-electrode-side first negative electrode current collector 531 is connected to the negative electrode current collecting portion 120N by laser welding, ultrasonic welding, or the like.

The negative-electrode-side second negative electrode current collector 532 is formed of a thin plate-shaped conductive member. The negative-electrode-side second negative electrode current collector 532 is connected to the negative-electrode-side first negative electrode current collector 531 by laser welding, ultrasonic welding, or the like. The negative-electrode-side second negative electrode current collector 532 has a holding portion 532a for holding the negative electrode connecting pin 533. The holding portion 532a has a flat plate shape. The holding portion 532a is provided with a through hole into which the proximal end of the negative electrode connecting pin 533 is inserted.

The negative electrode connecting pin 533 connects the negative-electrode-side second negative electrode current collector 532 to the negative electrode terminal plate 521. The negative electrode connecting pin 533 includes a cylindrical portion. The tip end side of the cylindrical portion penetrates through the sealing body 510, the insulating plate 522, and the negative electrode terminal plate 521, and is caulked to the negative electrode terminal plate 521.

The positive electrode connecting member 630 connects the positive electrode current collecting portion 110P and the positive electrode terminal plate 621. The positive electrode current collecting portion 110P is formed by bundling a plurality of positive electrode tabs 112p to be described later in the electrode assembly 100. The positive electrode connecting member 630 includes a positive-electrode-side first positive electrode current collector 631, a positive-electrode-side second positive electrode current collector 632, and a positive electrode connecting pin 633.

The positive-electrode-side first positive electrode current collector 631 is formed of a thin plate-shaped conductive member. The positive-electrode-side first positive electrode current collector 631 is connected to the positive electrode current collecting portion 110P by laser welding, ultrasonic welding, or the like.

The positive-electrode-side second positive electrode current collector 632 is formed of a thin plate-shaped conductive member. The positive-electrode-side second positive electrode current collector 632 is connected to the positive-electrode-side first positive electrode current collector 631 by laser welding, ultrasonic welding, or the like. The positive-electrode-side second positive electrode current collector 632 has a holding portion 632a for holding the positive-electrode connecting pin 633. The holding portion 632a has a flat plate shape. The holding portion 632a is provided with a through hole into which the base end of the positive electrode connecting pin 633 is inserted.

The positive electrode connecting pin 633 connects the positive-electrode-side second positive electrode current collector 632 and the positive electrode terminal plate 621. The positive electrode connecting pin 633 includes a cylindrical portion. The tip end side of the cylindrical portion penetrates through the sealing body 510, the terminal block 622, and the positive electrode terminal plate 621, and is caulked to the positive electrode terminal plate 621.

The first insulating member 540 has a substantially plate shape. The first insulating member 540 is disposed in contact with the inner surface of the sealing body 510. The first insulating member 540 is provided with a through hole 542 through which the negative electrode connecting pin 533 is inserted, and a through hole 642 through which the positive electrode connecting pin 633 is inserted.

The second insulating member 550 is disposed between the first insulating member 540 and the electrode assembly 100. The second insulating member 550 is provided with a slit 552 through which the negative electrode current collecting portion 120N is inserted and a slit 652 through which the positive electrode current collecting portion 110P is inserted.

The first insulating member 540 and the second insulating member 550 are assembled such that a housing space is formed therebetween. A negative electrode current collecting portion 120N inserted through the slit 552, a negative-electrode-side first negative electrode current collector 531, a negative-electrode-side second negative electrode current collector 532, a positive electrode current collecting portion 110P inserted through the slit 652, a positive-electrode-side first positive electrode current collector 631, and a positive-electrode-side second positive electrode current collector 632 are disposed in the housing space.

The insulator 560 has a shape that covers the cylindrical portion of the negative electrode connecting pin 533. The insulator 560 insulates the negative electrode connecting pin 533 from the housing 200 (more specifically, the sealing body 510).

The insulator 660 has a shape that covers the cylindrical portion of the positive electrode connecting pin 633. The insulator 660 insulates the positive electrode connecting pin 633 from the housing 200 (more specifically, the sealing body 510).

The negative electrode member 520, the positive electrode member 620, the sealing body 510, the negative electrode connecting member 530, the positive electrode connecting member 630, the first insulating member 540, the second insulating member 550, and the insulators 560, 660 are incorporated to form the lid assembly 50.

The lid assembly 50 is fixed to the main body 210 by attaching the sealing body 510 to the opening OP in a state where the negative electrode current collecting portion 120N and the negative electrode connecting member 530 are fixed by welding or the like, and the positive electrode current collecting portion 110P and the positive electrode connecting member 630 are fixed by welding or the like.

The sealing body 510 may further include a second liquid injection port 572 and a second sealing member 574. Similar to the liquid injection port 224, the second liquid injection port 572 is a through hole for injecting an electrolyte solution into the housing 200 during the manufacturing process of the secondary battery 10. The second sealing member 574 seals the second liquid injection port 572. The second sealing member 574 is provided to seal the second liquid injection port 572 after the electrolyte solution is injected into the housing 200.

FIG. 6 is a cross-sectional view taken along the line VI-VI shown in FIG. 1. In FIG. 6, for the sake of convenience, the housing 200 of the secondary battery 10 is omitted, and only the electrode assembly 100 is shown. The details of the electrode assembly 100 will be described with reference to FIG. 6.

As shown in FIG. 6, the electrode assembly 100 includes a plurality of positive electrodes 110, a plurality of negative electrodes 120, and a separator 130. The plurality of positive electrodes 110 and the plurality of negative electrodes 120 are arranged alternately in the thickness direction T while being insulated by the separator 130.

Each of the negative electrodes 120 is formed in a rectangular shape in which the width direction W is the long side and the height direction H is the short side. Each negative electrode 120 includes a negative electrode current collector foil 122 and a negative electrode active material layer 124 provided on both surfaces of the negative electrode current collector foil 122. The negative electrode current collector foil 122 has a negative electrode tab 122n (see FIG. 3) in which the negative electrode active material layer 124 is not provided. The negative electrode tab 122n protrudes toward one side in the width direction W.

Each positive electrode 110 is formed in a rectangular shape in which the width direction W is the long side and the height direction H is the short side. Each positive electrode 110 includes a positive electrode current collector foil 112, and positive electrode active material layers 114 provided on both surfaces of the positive electrode current collector foil 112 in the thickness direction T. The positive electrode current collector foil 112 has a positive electrode tab 112p (see FIG. 3) in which the positive electrode active material layer 114 is not provided. Similarly to the negative electrode tab 122n, the positive electrode tab 112p protrudes toward one side in the width direction W.

The separator 130 insulates the positive electrode 110 from the negative electrode 120. The separator 130 is made of an insulating material, and has minute voids that allow penetration of ions. The separator 130 is folded.

The separator 130 has a rectangular shape before being folded. The separator 130 is disposed between the positive electrode 110 and the negative electrode 120 in a folded state. The separator 130 includes a plurality of intervening portions 132a, a plurality of first folded portions 132b, a plurality of second folded portions 132c, and an outermost covering portion 132d.

The intervening portions 132a are interposed between the positive electrode 110 and the negative electrode 120 adjacent to each other in the thickness direction T. That is, each intervening portion 132a has a function of insulating the positive electrode 110 and the negative electrode 120. Each intervening portion 132a is configured by a rectangular region.

The first folded portions 132b connect one end of the intervening portions 132a in the height direction H adjacent to each other in the thickness direction T so that the positive electrodes 110 are positioned therebetween. The first folded portion 132b is disposed on one side (upper side) in the height direction H of the positive electrode 110.

The second folded portions 132c connect the other end portions of the intervening portions 132a adjacent to each other in the thickness direction T in the height direction H so that the negative electrodes 120 are positioned therebetween. The second folded portion 132c is disposed on the other side (lower side) of the negative electrode 120 in the height direction H.

The outermost covering portions 132d collectively cover the first folded portions 132b and the second folded portions 132c. More specifically, the outermost covering portion 132d covers all of the positive electrodes 110, all of the negative electrodes 120, all of the intervening portions 132a, all of the first folded portions 132b, and all of the second folded portions 132c while winding around the central axis parallel to the width direction W. The terminal end 132e of the outermost covering portion 132d is set in a range not overlapping the positive electrode active material layer 114 and the negative electrode active material layer 124 in the thickness direction T. In the present embodiment, the terminal end 132e of the outermost covering portion 132d is provided below each positive electrode 110 and each negative electrode 120. The peripheral surfaces and bottom surfaces of the plurality of positive electrodes 110, the plurality of negative electrodes 120, and the separator 130 may be covered with an insulating film (not shown).

As described above, in the secondary battery 10 according to the embodiment of the present disclosure, the end face weld 220 connects the leading end of the first end face portion 216A and the leading end of the second end face portion 216B to each other. The leading end of the first end face portion 216A is located closer to the center of the housing 200 in the width direction W, than the joint at which the first end face portion is connected to the first side surface portion 215A. The leading end of the second end face portion 216B is located closer to the center of the housing 200 in the width direction W, than the joint at which the second end face portion is connected to the second side surface portion 215B.

According to the above configuration, since the respective leading ends of the first end face portion 216A and the second end face portion 216B are positioned as described above, it is possible to suppress the end face weld 220 from protruding in the width direction W particularly when the end face weld 220 includes a weld bead.

Further, the end face weld 220 extends only in one direction along the height direction H. Thereby, the welding length of the end face weld 220 can be shortened. Consequently, welding strain of the housing 200 can be suppressed.

Further, the first end face portion 216A includes a first base portion 217A, a first inner surface portion 218A, and a first leading end portion 219A. The first base portion 217A is contiguous from the first side surface portion 215A and extends in the thickness direction T. The first inner surface portion 218A extends from the first base portion 217A toward the center side of the housing 200. The first leading end portion 219A extends from the first inner surface portion 218A along the thickness direction T, and has a leading end of the first end face portion 216A. The second end face portion 216B includes a second base portion 217B, a second inner surface portion 218B, and a second leading end portion 219B. The second base portion 217B is contiguous from the second side surface portion 215B and extends in the thickness direction T. The second inner surface portion 218B extends from the second base portion 217B toward the center side of the housing 200. The second leading end portion 219B extends from the second inner surface portion 218B along the thickness direction T, and has a leading end of the second end face portion 216B. The end face weld 220 is located on the first leading end portion 219A and the second leading end portion 219B. The end face weld 220 is located closer to the center of the housing 200 than the first base portion 217A and the second base portion 217B in the width direction W.

According to the above configuration, since the first base portion 217A and the second base portion 217B extend along the thickness direction T, the entire area of the end face of the main body 210 can be reduced. Further, since the first leading end portion 219A and the second leading end portion 219B also extend along the thickness direction T, it is easy to form the end face weld 220 by abutting them. Further, since the end face weld 220 is positioned on the first leading end portion 219A and the second leading end portion 219B, the end face weld 220 can be further suppressed from protruding in the width direction W.

The main body 210 further includes a liquid injection port 224 and a sealing member 225. The liquid injection port 224 is provided between the first leading end portion 219A and the second leading end portion 219B. The sealing member 225 seals the liquid injection port 224. The sealing member 225 is located closer to the center of the housing 200 than the first base portion 217A and the second base portion 217B in the width direction W.

According to the above configuration, the liquid injection port 224 can be easily provided without punching out the plate-shaped member constituting the main body 210. In addition, contact of the sealing member 225 with other articles on the secondary battery 10 side can be suppressed. Therefore, handling of the secondary battery 10 becomes easier.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A secondary battery comprising:
an electrode assembly; and
a housing containing the electrode assembly, wherein
the housing has a dimension in a height direction, a dimension in a thickness direction orthogonal to the height direction, and a dimension in a width direction orthogonal to both the height direction and the thickness direction, and the dimension in the width direction is longer than the dimension in the height direction and the dimension in the thickness direction,
the housing includes a main body provided with an opening, and a sealing body closing the opening,
the main body includes:
a bottom surface portion located on one side in the height direction;
a first side surface portion extending upright along the height direction, from one end of the bottom surface portion in the thickness direction;
a second side surface portion extending upright along the height direction, from the other end of the bottom surface portion in the thickness direction;
a first end face portion extending toward the second side surface portion, from one end of the first side surface portion in the width direction;
a second end face portion extending toward the first side surface portion, from one end of the second side surface portion in the width direction; and
an end face weld connecting a leading end of the first end face portion and a leading end of the second end face portion to each other,
the leading end of the first end face portion is located closer to a center of the housing in the width direction, than a joint at which the first end face portion is connected to the first side surface portion, and
the leading end of the second end face portion is located closer to the center of the housing in the width direction, than a joint at which the second end face portion is connected to the second side surface portion.

2. The secondary battery according to claim 1, wherein the end face weld extends only in one direction along the height direction.

3. The secondary battery according to claim 1, wherein
the first end face portion includes: a first base portion contiguous to the first side surface portion and extending along the thickness direction; a first inner surface portion extending from the first base portion toward the center of the housing; and a first leading end portion extending from the first inner surface portion along the thickness direction and including the leading end of the first end face portion,
the second end face portion includes: a second base portion contiguous to the second side surface portion and extending along the thickness direction; a second inner surface portion extending from the second base portion toward the center of the housing; and a second leading end portion extending from the second inner surface portion along the thickness direction and including the leading end of the second end face portion, and
the end face weld is located on the first leading end portion and the second leading end portion, and located closer to the center of the housing in the width direction, than the first base portion and the second base portion.

4. The secondary battery according to claim 3, wherein
the main body further includes: a liquid injection port provided between the first leading end portion and the second leading end portion; and a sealing member sealing the liquid injection port, and
the sealing member is located closer to the center of the housing in the width direction, than the first base portion and the second base portion.

5. The secondary battery according to claim 4, wherein the end face weld extends only in one direction along the height direction.
